(19) United States
(12) Patent Application Publication
(10) Pub. No.: US 2018/0018833 A1
(43) Pub. Date: Jan. 18, 2018

(54) Vehicle Database Storage And Retrieval Methods And Systems

(71) Applicant: Ford Global Technologies, LLC, Dearborn, MI (US)

(72) Inventor: Meiyappan Kannappa, Santa Clara, CA (US)

(21) Appl. No.: 15/213,085

(22) Filed: Jul. 18, 2016

(51) Int. Cl. G07C 5/00; G06F 17/30; H04L 29/08

(52) U.S. Cl. CPC G07C 5/008; H04L 67/12; G06F 17/30312; G06F 17/30386; H04L 67/1097

(57) ABSTRACT

A method for storing and retrieving vehicle information where raw vehicle data is stored on a database hosted by a vehicle. The raw vehicle data describes vehicle operations and status. A remote server in communication with the vehicle receives a request for desired information and transmits the request to the vehicle. The vehicle receives the request and generates the desired information from the raw vehicle data. The vehicle returns the desired information to the requesting device via the remote server. A corresponding system is also disclosed and claimed herein.

### BACKGROUND

### Field of the Invention

This invention relates to systems and methods for storing and retrieving vehicle data.

### Background of the Invention

Vehicle owners, service centers, and manufacturers rely on various types of vehicle data such as odometer readings, fluid levels, driving data, location data, and diagnostic codes to monitor and improve vehicle performance, diagnose problems, increase efficiency, and perform repairs. Obtaining this information oftentimes requires manually inspecting instruments or gauges, and/or removing and checking dipsticks or inspecting fluid reservoirs to determine fluid levels and the like. In some cases, obtaining such information may require physically driving a vehicle to a service center where a technician can connect the vehicle to appropriate diagnostic and data retrieval tools. These processes can be time-consuming and inconvenient not only for a vehicle owner, but also for a service center and/or manufacturer. Manually retrieving information may also be subject to human errors and inaccuracies.

Even if information manually obtained from a vehicle is accurate, such information may be limited to a vehicle's current status. That is, the information may not reflect historical changes or readings over a period of time that may be helpful to monitor and improve vehicle performance, diagnose problems, increase efficiency, and/or perform repairs. A current odometer reading, for example, may not enable a vehicle owner to gauge the number of miles that are being put on a vehicle over a specific time period, or the type of miles (e.g., whether the miles are city or highway miles). Similarly, a current oil or coolant level may not provide information related to an amount of oil or coolant the vehicle is consuming or leaking over a period of time.

In view of the foregoing, what are needed are systems and methods to acquire vehicle information reflecting not only a current status of a vehicle but also over a period of time. Ideally, such systems and methods would enable retrieval or calculation of such information from a location remote from the vehicle. Further needed is access to substantially real-time vehicle data without requiring physical interaction with the vehicle.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a computing system in which a system and method in accordance with the invention may be implemented;

FIG. 2 is a high-level diagram showing a system for storing and retrieving vehicle information in accordance with certain embodiments of the invention;

FIG. 3 shows example modules for providing various features and functions of a system in accordance with the invention;

FIG. 4 shows one embodiment of a system for retrieving raw vehicle data in accordance with the invention;

FIG. 5 shows an embodiment for retrieving vehicle information derived from an algorithm in accordance with the invention;

FIG. 6 shows an embodiment for retrieving vehicle information and executing a vehicle function in response to the information in accordance with the invention; and

FIG. 7 is a flow chart showing a process for storing and retrieving vehicle information in accordance with certain embodiments of the invention.

### DETAILED DESCRIPTION

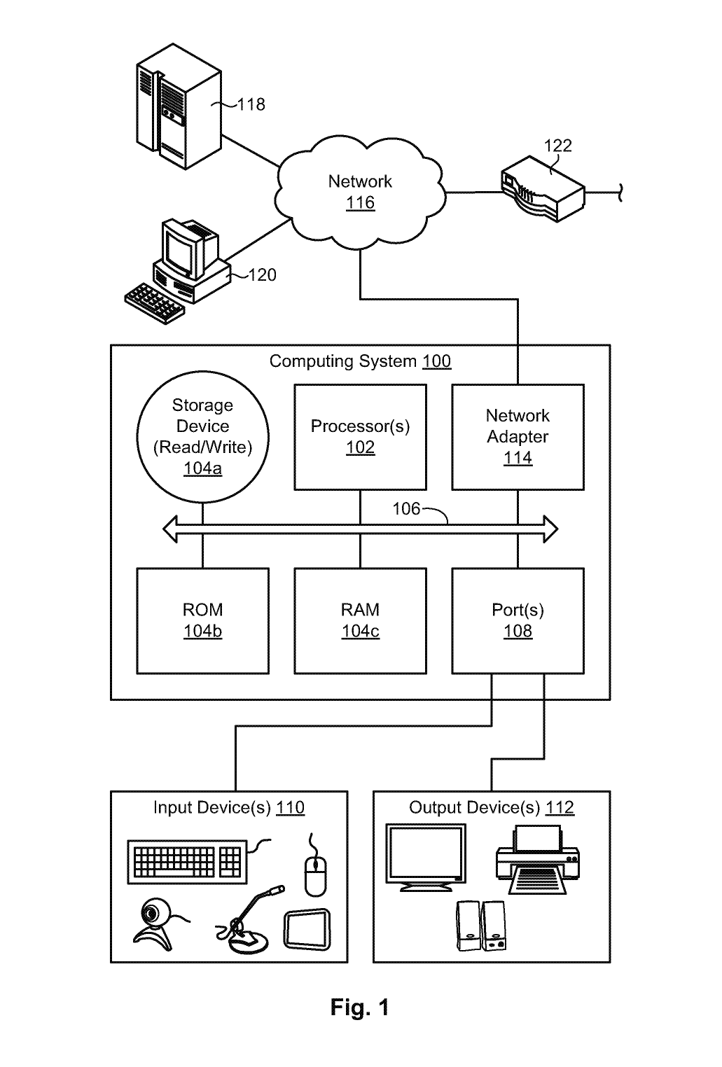

Referring to FIG. 1, one example of a computing system 100 is illustrated. The computing system 100 is presented to show one example of an environment where a system and method in accordance with the invention may be implemented. The computing system 100 may be embodied as a mobile device 100 such as a smart phone or tablet, a desktop computer, a workstation, a server, or the like. The computing system 100 is presented by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a LAN, WAN, or the Internet. Such a network 116 may enable the computing system 100 to connect to one or more servers 118, workstations 120, personal computers 120, mobile computing devices, or other devices. The network 116 may also enable the computing system 100 to connect to another network by way of a router 122 or other device 122. Such a router 122 may allow the computing system 100 to communicate with servers, workstations, personal computers, or other devices located on different networks.

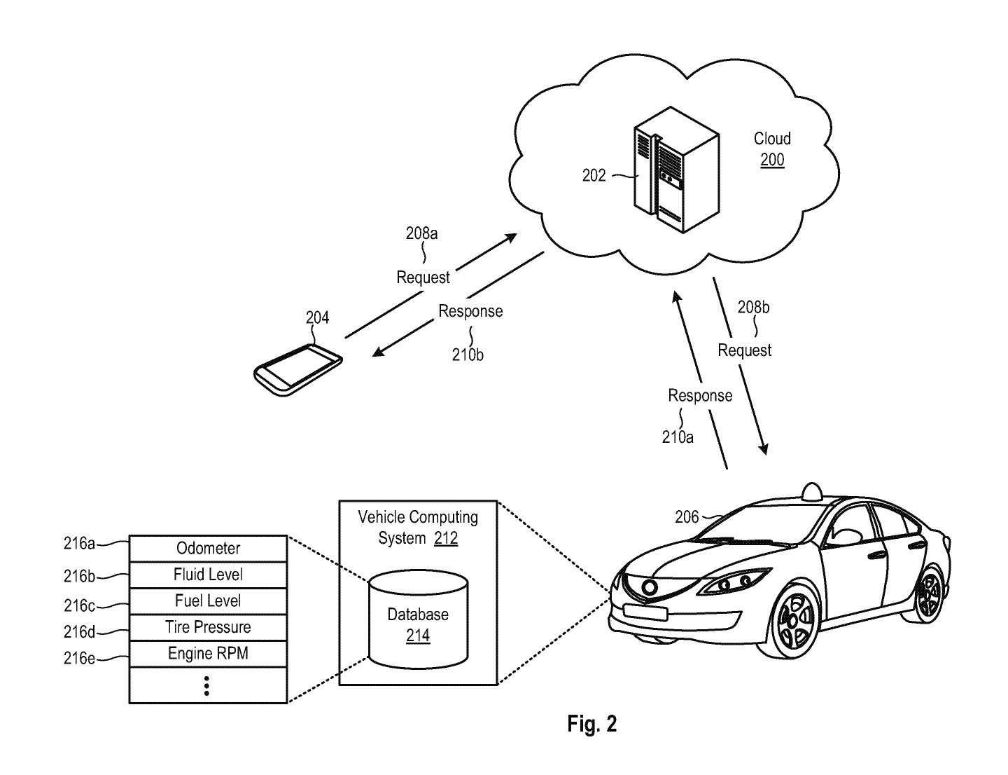

Referring now to FIG. 2, a system in accordance with certain embodiments of the invention may include a motor vehicle 206 communicating with a requesting device 204 over the Internet, or “cloud” 200, using an appropriate communications protocol. Although the example of FIG. 2 includes cloud 200, alternate embodiments may use any communication mechanism or communication network. The cloud 200 may include a cloud server 202 to process requests 208 received from a requesting device 204 such as a cellular phone, a smart phone, a tablet computer, a stationary computer, a handheld mobile computing device, or the like. An authorized user such as an owner, a service technician, the vehicle manufacturer, or other authorized individual may utilize the requesting device 204 to communicate with the motor vehicle 206 to obtain desired information. In some embodiments, requesting device 204 and motor vehicle 206 communicate through one or more remote servers (or other remote computing devices) coupled to cloud 200 or independent of cloud 200.

In some embodiments, a persistent connection between the motor vehicle 206 and the requesting device 204 over the Internet may facilitate reliable communication. For example, the motor vehicle 206 may keep open a single TCP connection to send and receive multiple requests and responses from the requesting device 204. Use of a persistent connection may increase communication efficiencies by enabling the motor vehicle 206 to constantly pull for a network connection rather than opening a new connection for every request/response pair. In this manner, an authorized user may reliably receive up-to-date information from the motor vehicle 206. In other embodiments, communication may occur over a secure asynchronous connection.

The motor vehicle 206 may include a vehicle computing system 212 integrated into the vehicle 206. The vehicle computing system 212 may include a database 214 hosted by the vehicle 206 and storing raw vehicle data such as vehicle location data, oil pressure data, battery charge levels, temperature levels, odometer readings 216a, fluid levels 216b, fuel levels 216c, pressure levels 216d, engine revolutions per minute (RPM) 216e, vibration data, vacuum levels, sensor data, camera data, vehicle proximity data, and the like. The database 214 may also include timestamps for each of the above-mentioned raw vehicle data that indicates when the data was recorded.

In operation, the cloud server 202 may receive a request 208a for desired information from the requesting device 204. The desired information may comprise, for example, a current or previous odometer reading 216a, fluid level 216b, fuel level 216c, tire pressure 216d, engine revolutions per minute (RPM) reading 216e, or other raw vehicle data. The cloud server 202 may then transmit the request 208b to the vehicle 206 for the desired information. The request 208b may be transmitted to the vehicle 206 over a persistent connection, as previously discussed.

Upon receipt of the request 208b, the vehicle 206 may locate the desired information in the database 214 and return it 210a to the cloud server 202. The cloud server 202 may then return 210b the desired information to the requesting device 204 for access by the device 204 or user.

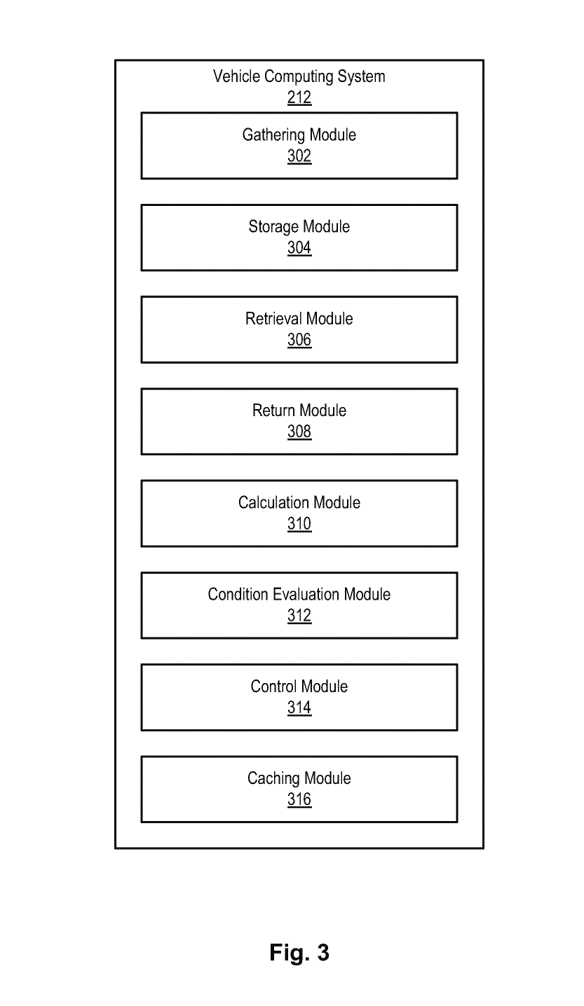

Referring now to FIG. 3, a system in accordance with the invention may include various modules to provide different features and functions. The functionality of these modules may be implemented in one or more of the requesting device 204, cloud server 202, and vehicle computing system 212. The modules may include one or more of a gathering module 302, storage module 304, retrieval module 306, return module 308, calculation module 310, condition evaluation module 312, control module 314 and caching module 316. These modules may be implemented in hardware, software, firmware, or combinations thereof. The modules are presented by way of example and are not intended to represent an exhaustive list of modules that may be included within the system. The system may include more or fewer modules than those illustrated, or the functionality of the modules may be organized differently.

The gathering module 302 may gather from the vehicle 206 raw vehicle data describing real-time vehicle operations and status. In some embodiments, for example, the raw vehicle data may include battery charge levels, engine revolutions per minute, engine temperature, fuel levels, fluid flow rates, fluid levels, tire air pressure, vehicle location, vehicle speed, vehicle acceleration, sensor data, camera data, vehicle proximity data, odometer reading, accelerometer data, orientation data, weight data, and the like.

The storage module 304 may store the raw vehicle data gathered by the gathering module 302 in a database 214 hosted by a vehicle 206. The storage module 304 may format and organize the raw vehicle data to facilitate accessibility in the database 214.

The retrieval module 306 may receive a request for desired vehicle information and locate the desired information in the database 214. Where the request for desired information is a request for raw vehicle data, the retrieval module 306 may retrieve the desired information from the database 214 and forward the information to the return module 308, which may return the desired information to the requesting device 204.

In some embodiments, the desired vehicle information may require performing a calculation using the raw vehicle data as input. In this case, the calculation module 310 may analyze the raw vehicle data and perform one or more calculations using the raw vehicle data as input. The calculation module 310 may utilize the vehicle computing system 212 to perform such calculations and, in some cases, may store the result in the database 214.

In this manner, embodiments of the present invention may use the vehicle 206 as the primary location for storing and retrieving data, as opposed to storing and retrieving vehicle from a cloud server or other similar device. Storing certain results in the database 214 may reduce the need to recalculate the results in the event they are needed again. This, in turn, may reduce latency for frequently requested information.

In one embodiment, for example, a requesting device 204 may request, from a vehicle 206, a driving pattern analysis that includes speed and acceleration profiles, fuel consumption, and emissions. As previously described, raw vehicle data may include speed data, fuel level, and emissions, and may be substantially continuously gathered by the gathering module 302 and stored by the storage module 304. Accordingly, the in-vehicle database 214 may contain raw vehicle data describing a speed of the vehicle 206 over time with correlating time stamps. The in-vehicle database 214 may also contain raw vehicle data describing fuel levels and emissions over time, also with correlating time stamps.

Upon receiving the request for the driving pattern analysis, the retrieval module 306 may retrieve the speed of the vehicle 206 over time with correlating time stamps, as well as fuel levels and emissions over time with correlating time stamps, from the database 214. Instead of simply returning this raw vehicle data to the requesting device 204 via the return module 308, the calculation module 310 may first use the raw vehicle data as input to calculate average speed and acceleration of the vehicle 206 over time, as well as fuel consumption and emissions over time. These results may constitute the desired vehicle information (i.e., requested driving pattern analysis).

In some embodiments, the storage module 304 may store the results in the database 214 in the event it is requested again. The return module 308 may then forward the results to the requesting device 204.

In some embodiments, the request for desired information may include a request to perform a vehicle function, such as locking vehicle doors, turning down audio volume, reducing speed, preventing vehicle operation, etc. In certain embodiments, the request may be conditional, meaning that the vehicle computing system 212 may need to assess whether a certain condition exists or is satisfied prior to executing the vehicle function.

Accordingly, a condition evaluation module 312 of the vehicle computing system 212 may receive the request from the requesting device 204. The condition evaluation module 312 may evaluate whether the condition has been satisfied by, for example, comparing current raw vehicle data in the database 214 with a predetermined threshold value. In some embodiments, the condition evaluation module 312 may compare the results of a calculation performed by the calculation module 310 with a predetermined value or with prior calculation results.

If the condition has been satisfied, the control module 314 may execute the vehicle function in accordance with the request. The control module 314 may then generate feedback verifying performance or non-performance to the return module 308 for return to the requesting device 204.

In one embodiment, a caching module 316 may cache the returned information or feedback in an internal cache of the cloud server 202 to facilitate quick access to the information in the event it is requested again.

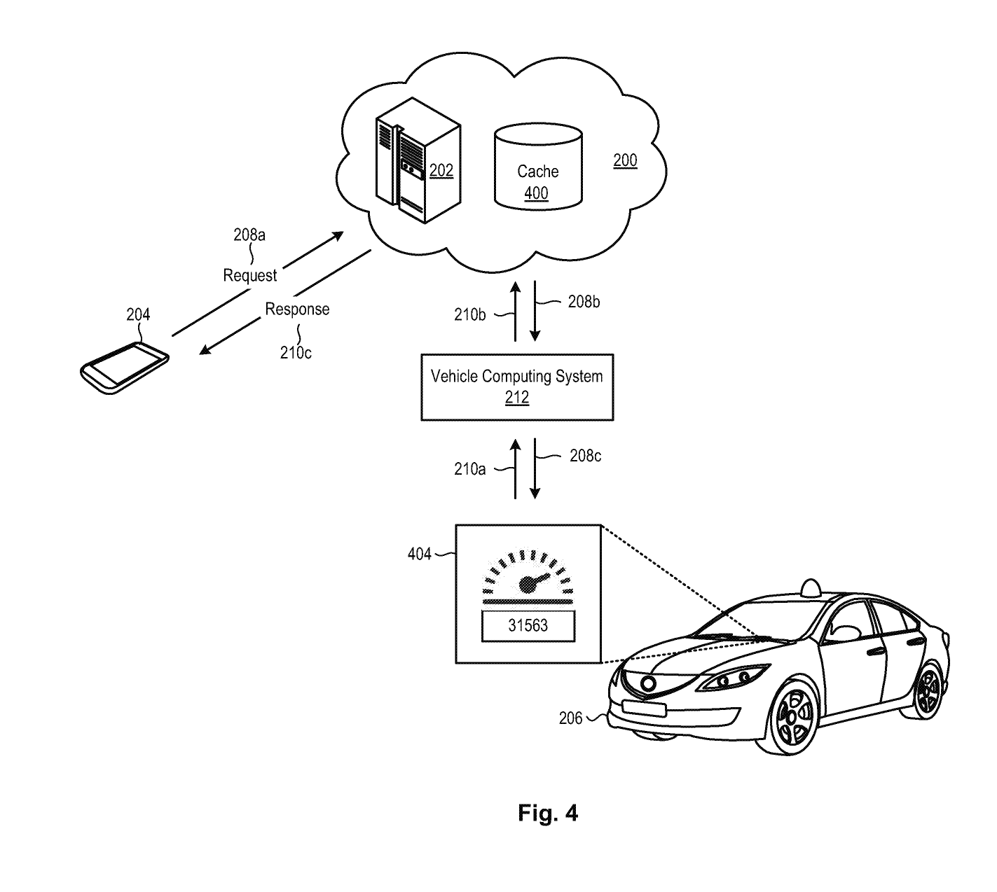

Referring now to FIG. 4, in one embodiment a service technician or other user may utilize a requesting device 204 to query the vehicle 206 for a current odometer reading 404. To execute the request, the requesting device 204 may send the request 208a to a cloud server 202 in communication with the vehicle 206. Upon receipt of the request 208a, the cloud server 202 may transmit the request 208b to the vehicle 206. The request 208b may be received by a vehicle computing system 212 of the vehicle 206.

In some embodiments, the vehicle computing system 212 authenticates the request 208b to verify the identity of the requesting device 204. For example, the vehicle computing system 212 may store authentication information such as passwords or biometric information. The vehicle computing system 212 may compare authentication information provided by the requesting device 204 with the authentication information stored to verify a match. This will ensure that information stored in the in-vehicle database 214 cannot be accessed in an unauthorized manner.

In certain embodiments, authenticating the requesting device 204 may provide only temporary authorization to use or control a vehicle 206. For example, authentication information provided by the requesting device 204 may only authorize a single-time access (or other number of times of access) of the vehicle 206. In other embodiments, authentication information provided by the requesting device 204 may only authorize use of the vehicle 206 for a selected period of time.

If authentication is successful, the vehicle computing system 212 may process the request 208b and retrieve the information—in this case, the current odometer reading 404—from the in-vehicle database 214.

The current odometer reading 404 may be returned 210a, 210b, 210c to the requesting device 204 via the cloud server 202 for access by the service technician or other user. In some cases, the odometer reading 404 may be temporarily cached in the in-vehicle database 214, a cache 400 associated with the cloud server 202, or elsewhere.

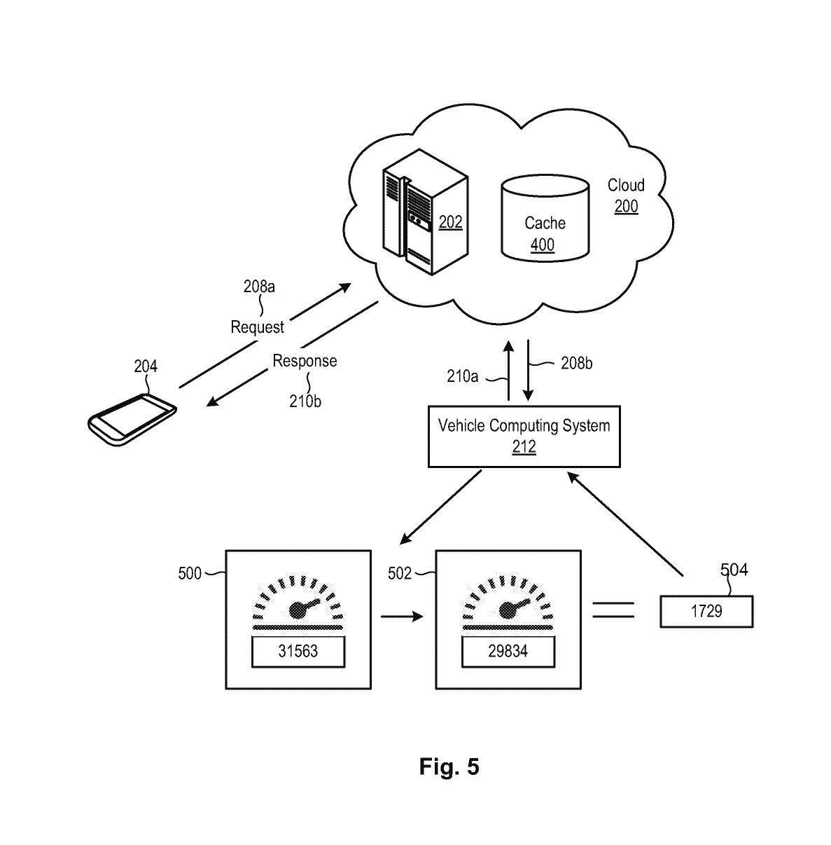

Referring now to FIG. 5, in another embodiment, a vehicle owner may utilize a cell phone or other requesting device 204 to obtain trip mileage information from the vehicle 206. The requesting device 204 may send a request 208a to the vehicle 206 via the cloud 200. The request 208a may be received by a cloud server 202 in communication with the vehicle 206. The cloud server 202 may then direct the request 208b to the vehicle 206. The request 208b may be received by the vehicle computing system 212. The vehicle computing system 212 may authenticate the requesting device 204 and process the request 208b.

In this embodiment, retrieval of the desired information (i.e., trip mileage) requires the vehicle computing system 212 to first perform an algorithm using odometer readings corresponding to the beginning of the trip and to the end of the trip. To this end, the vehicle computing system 212 may retrieve a first odometer reading with a time stamp corresponding to the end of the trip 500, and a second odometer reading with a time stamp corresponding to the beginning of the trip 502. The two odometer readings 500, 502 may be compared to render a resulting trip mileage 504.

The resulting trip mileage 504 may be identified by the vehicle computing system 212 as the desired information and returned 210a, 210b to the requesting device 204 via the cloud server 202. In some embodiments, the result 504 may also be cached in the vehicle database 214 or the in-cloud cache 400.

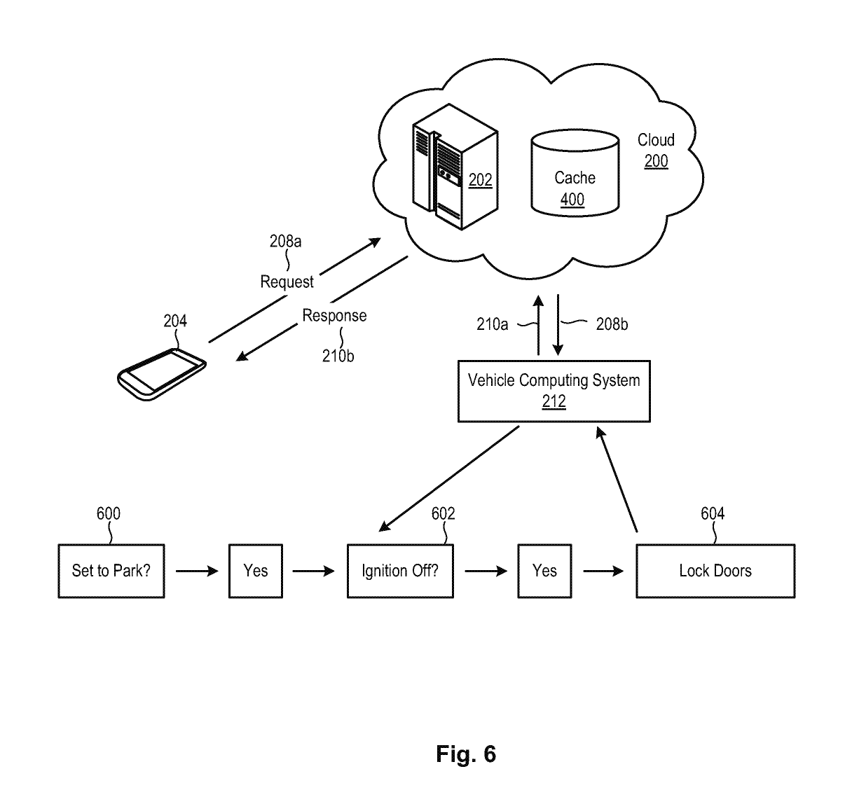

Referring now to FIG. 6, in other embodiments, a vehicle owner may desire to impose limits on a vehicle 206 remotely when, for example, a child is using the vehicle 206. In this situation, the owner may utilize embodiments of the present invention to detect whether a current speed or acceleration of the vehicle 206 exceeds a predetermined threshold, and may then reduce its speed as necessary to meet the threshold. In other embodiments, the owner may remotely detect whether, for example, seatbelts are unfastened or an oil level is low, and may prevent the vehicle 206 from operating under such conditions.

Such embodiments of the invention may also be useful for manufacturers or owners of autonomous vehicles. For example, embodiments of the present invention may be implemented to remotely limit or control vehicle 206 functions under certain conditions pertaining to temperature, speed, location, and the like.

As shown in FIG. 6, in one embodiment a vehicle 206 owner may desire to lock the doors of the vehicle 206 if the vehicle 206 is parked. The vehicle 206 owner may utilize a requesting device 204 such as a cell phone to send the request 208a to the vehicle 206. The request 208a may be routed via the cloud 200 to a cloud server 202 in communication with the vehicle 206. The cloud server 202 may then send the request 208b to the vehicle 206 via the vehicle computing system 212.

Upon proper authentication, the vehicle computing system 212 may retrieve the raw vehicle data needed to determine whether the necessary conditions have been satisfied prior to executing the request 208b. For example, to determine whether the vehicle 206 is parked, the vehicle computing system 212 must make a two-part determination—first, whether the vehicle 206 has been set to park 600, and second, whether the ignition has been turned off 602. If both conditions are satisfied, the vehicle computing system 212 may perform the requested function 604 of locking the vehicle 206 doors.

Beneficially, these determinations may take place in the vehicle computing system 212 of the vehicle 206, without necessitating cloud storage for analysis or processing. Upon locking the doors 604 as requested, the vehicle computing system 212 may return 210a, 210b positive feedback to the requesting device 204 via the cloud server 202.

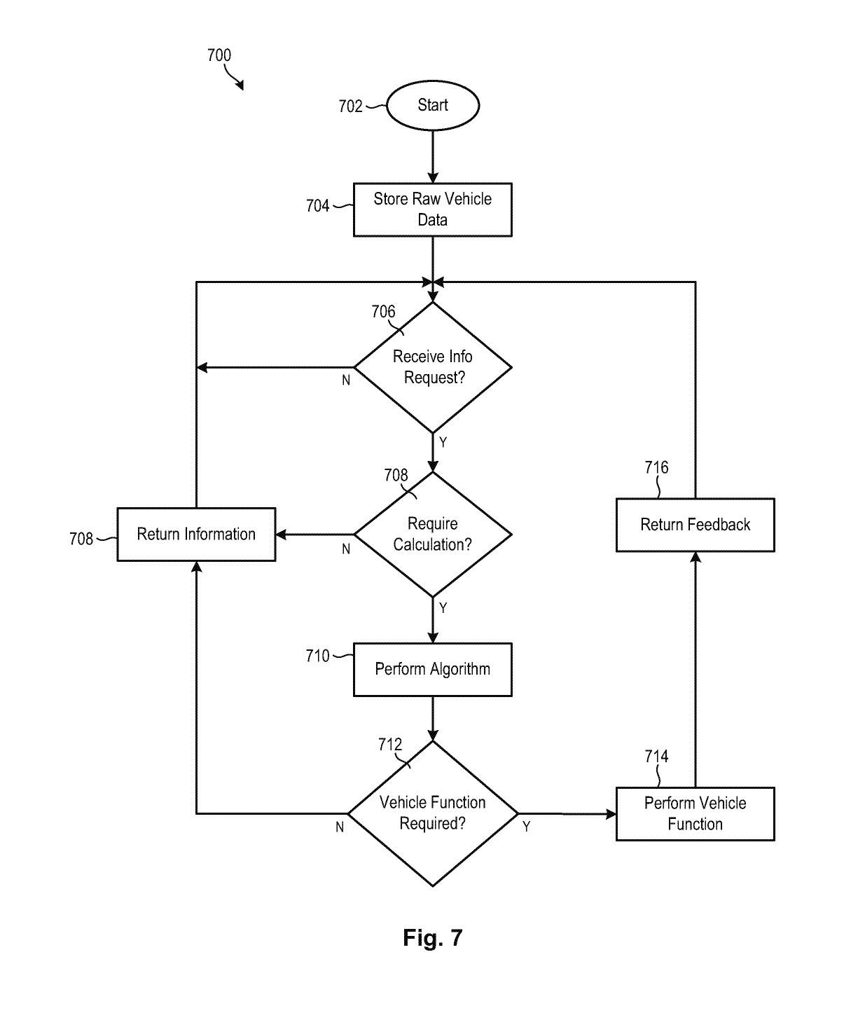

Referring now to FIG. 7, a method 700 in accordance with embodiments of the invention may start 702 by storing 704 raw vehicle data in a database 214 hosted by a vehicle. As described above, raw vehicle data may include, for example, on-board diagnostics, battery charge levels, vacuum levels, vibration, temperature levels, odometer readings, fluid levels, fuel levels, pressure levels, engine revolutions per minute, and the like.

Once raw vehicle data is stored, the method 700 may query whether a request for desired information has been received 706. If no, the method 700 may continue to check for information requests 706. If yes, the method 700 may then query whether the request requires a calculation 708 using the raw vehicle data as input. If not, the desired raw vehicle information may be retrieved from the database and returned 708 to the requesting device 204.

If the request for desired information requires a calculation, the method 700 may perform 710 an appropriate algorithm using the raw vehicle data as input. The method 700 may then query whether the request for desired information requires 712 performance of a vehicle function. As discussed above with reference to FIG. 6, in some embodiments a request for desired information requires conditional performance of a vehicle function if the conditions are satisfied. One or more results from the previous algorithm step 710 may thus be used to determine whether performance of the vehicle function is required 712. If no vehicle function is required 712, the method 700 may return 708 the desired information to the requesting device 204.

If required 712, the vehicle function may be performed 714 in accordance with the request 706 parameters. The method 700 may then return feedback 716 to the requesting device to verify performance 712 of the vehicle function. In some embodiments, such as where the desired information includes both the result of a performed algorithm 710 and performance 714 of a vehicle function, the feedback 716 may include the algorithm result 710 as well as verification of vehicle function performance 714.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising:
storing, on a database hosted by a vehicle, raw vehicle data describing vehicle operations and status;
receiving, by the vehicle, a request for desired information from a remote server;
generating, by the vehicle, the desired information from the raw vehicle data; and
returning, by the vehicle, the desired information to a requesting device via the remote server.

2. The method of claim 1, wherein receiving the request comprises receiving the request over a persistent communication link.

3. The method of claim 1, wherein the desired information is the raw vehicle data.

4. The method of claim 1, wherein the desired information is calculated from the raw vehicle data using an algorithm.

5. The method of claim 1, wherein the raw vehicle data comprises at least one of an odometer reading, fluid level data, fuel level data, tire pressure data, engine RPM data, engine temperature data, oil pressure data, fluid flow rate data, vehicle location data, vehicle acceleration data, vehicle speed data, sensor data, camera data, vehicle proximity data, vibration data, accelerometer data, orientation data, weight data, and battery charge level data.

6. The method of claim 1, further comprising retrieving, by the vehicle from the database, the raw vehicle data needed to generate the desired information.

7. The method of claim 6, further comprising generating the desired information from the raw vehicle data using a processor at the vehicle.

8. The method of claim 1, wherein the desired information comprises at least one of trip data, trip comparison data, vehicle performance data, vehicle efficiency data, vehicle environmental data, and driving pattern data.

9. The method of claim 1, further comprising caching, by the remote server, the desired information.

10. The method of claim 1, further comprising performing, by the vehicle, at least one vehicle function in response to the request.

11. A system for storing and retrieving information from a vehicle, the system comprising:
at least one processor hosted by a vehicle; and
at least one memory device operably coupled to the at least one processor and storing instructions for execution on the at least one processor, the instructions causing the at least one processor to:
store, on a database hosted by the vehicle, raw vehicle data describing vehicle operations and status;
receive a request for desired information from a remote server;
generate the desired information from the raw vehicle data; and
return the desired information to a requesting device via the remote server.

12. The system of claim 11, wherein receiving the request comprises receiving the request over a persistent communication link.

13. The system of claim 11, wherein the desired information is the raw vehicle data.

14. The system of claim 11, wherein the instructions further cause the at least one processor to calculate the desired information from the raw vehicle data using an algorithm.

15. The system of claim 11, wherein the raw vehicle data comprises at least one of an odometer reading, fluid level data, fuel level data, tire pressure data, engine RPM data, engine temperature data, oil pressure data, fluid flow rate data, vehicle location data, vehicle acceleration data, vehicle speed data, sensor data, camera data, vehicle proximity data, vibration data, accelerometer data, orientation data, weight data, and battery charge level data.

16. The system of claim 11, wherein the instructions further cause the at least one processor to retrieve, from the database, the raw vehicle data needed to generate the desired information.

17. The system of claim 11, wherein the desired information comprises at least one of trip data, trip comparison data, vehicle performance data, vehicle efficiency data, vehicle environmental data, and driving pattern data.

18. The system of claim 11, wherein the remote server is further configured to cache the desired information.

19. The system of claim 11, wherein the instructions further cause the at least one processor to compare the raw vehicle data with a predetermined threshold value to determine whether a condition has been satisfied.

20. The system of claim 11, wherein the instructions further cause the at least one processor to perform at least one vehicle function in response to the request.
